(19) United States
(12) Patent Application Publication
(10) Pub. No.: US 2026/0235033 A1
(43) Pub. Date: Aug. 13, 2026

(54) VANED IMPELLER FOR AIRCRAFT TURBOMACHINE, COMPRISING A DYNAMIC DAMPING DEVICE MADE USING A MEMBER FOR RECONSTITUTING A GAS CIRCULATION PATH

(71) Applicants: SAFRAN CERAMICS, LE HAILLAN (FR); SAFRAN AIRCRAFT ENGINES, PARIS (FR)

(72) Inventors: Mathieu Arnaud GIMAT, MOISSY-CRAMAYEL (FR); Patrick Joseph Marie GIRARD, MOISSY-CRAMAYEL (FR); Gilles Gérard Claude LEPRÊTRE, MOISSY-CRAMAYEL (FR); Romain Claude Gabriel BARDON, MOISSY-CRAMAYEL (FR); Denis Jean Armel BUSQUET, MOISSY-CRAMAYEL (FR); Clément Marie Benoît ROUSSILLE, MOISSY-CRAMAYEL (FR)

(21) Appl. No.: 19/155,972

(22) PCT Filed: Mar. 20, 2024
(86) PCT No.: PCT/FR2024/050341

§ 371 Date: Aug. 13, 2025

(30) Foreign Application Priority Data
Mar. 22, 2023 (FR) 2302695

(51) Int. Cl. F01D 5/22; F01D 5/28

(52) U.S. Cl. CPC F01D 5/225; F01D 5/282; F05D 2250/182; F05D 2260/36; F05D 2300/6033

(57) ABSTRACT

A vaned impeller for aircraft turbomachine, comprising several vanes with a heel circumferentially extending on either side of the blade tip respectively into a first heel portion, and a second heel portion. Between adjacent first vane and second vane of the impeller, the latter comprises a member for reconstituting a gas circulation path, arranged in a first recess provided on the radially inner surface of the first heel portion of the first vane, and in a second recess provided on the radially inner surface of the second heel portion of the second vane, the first and second recesses each having a bottom surface for cooperating by friction with a radially outer friction surface of the member.

### TECHNICAL FIELD

The present invention concerns the field of aircraft turbomachines, and more precisely the design of the vaned impellers forming turbines and compressors of these turbomachines. More specifically, it relates to the dynamic friction damping of the vanes, which succeed each other along the circumferential direction to form an annular row of vanes.

The invention applies to all turbomachine designs, for example turbojets directly driven by a low-pressure spool, or indirectly driven by a reduction gear.

### STATE OF PRIOR ART

Compressors and turbines of aircraft turbomachines are made by an axial succession of fixed and movable vaned impellers, also called stator vaned impellers, and rotor vaned impellers. In the case where such a vaned impeller is angularly sectorized, namely along the circumferential direction of the impeller, it is usually appropriate to limit vibratory stresses on the vanes adjacently arranged along the circumferential direction of the impeller.

To do this, means are implemented for ensuring dynamic damping of these sectors, by dissipating friction resonance energy between the vane heels. Such a damping solution is, for example, known from document FR 3 085 712A1.

Another more conventional solution is to implement a contact friction technology, between the heels of adjacent vanes having particular shapes. This technology, also known as “interlock”, is characterized by specifically cutting the two opposite circumferential faces of the heel, with a projection on the upper surface (extrados) side, and a complementary shape indentation on the lower surface (intrados) side. The two-to-two cooperation of these circumferential faces allows holding the two heels adjacent to each other, in the axial direction. This interlock technology is also referred to as “pre-twist”.

When mounting the vanes, the circumferential contact faces are placed in bearing position through an angular deformation of the blade, constituting the desired interlock.

In operation, vibrations of the vanes induce relative slippages on the circumferential faces of the heels, which, being coupled with the contact pressures, create frictional damping. With this technology, the contact force between the heels can vary during operation of the turbomachine. This variation can be derived from the natural rotation of the blade about its twist axis (clockwise or counterclockwise), or from the relative movement of the adjacent heels along the circumferential direction (moving closer or away). Upon mounting the vanes, it is necessary to take account of these possible variations in operation, and to ensure that at high speed, i.e. at the speed where dynamic damping is primarily sought, the target contact force is achieved. This can lead to a very high contact force being applied when mounting the vanes, which results in significant static overstresses, likely to embrittle the vanes and/or reduce their life time. This drawback turns out to be more or less demanding, depending on the material used and its ability to withstand such stresses. For example, for vanes made of ceramic matrix composite material, also known as CMC material, the permissible mechanical stresses often remain low, making the vanes poorly tolerant to this interlock principle. Thus, when a blade is made of CMC material, it may prove incompatible with the need to apply a high interlock upon mounting, required for the purposes of satisfactory damping at the desired speed.

Other dynamic damping solutions are known, such as assembling friction elements to the interface between the heels, at their circumferential faces that cooperate two by two. These solutions generally have the drawback of generating aerodynamic disturbances at the path.

### DISCLOSURE OF THE INVENTION

In order to remedy the aforementioned drawbacks, a first object of the invention is a vaned impeller for aircraft turbomachine, according to the characteristics of each of claims 1 and 6.

Thus, the invention is based globally on splitting the existing heels into several pieces, in particular so as to provide the dynamic damping function, by friction between these pieces.

The invention thus provides a simple, reliable, efficient and low-mass solution to the problems set out previously, and the principle of which makes it possible to dispense with restrictions associated with the principle of interlock of the vanes encountered in prior art. In particular, it is no longer necessary to introduce high static interlock stresses in the angular sectors when mounting them, and machining complementary complex shapes on the opposite circumferential faces of the heels is no longer required. Advantageously, the invention allows the use of various materials for making the vanes, including CMC materials.

In the invention, the path reconstituting member can therefore come into contact with the heel portions in which the recesses are provided, forming a kind of indentations. This allows generating, under the effect of the centrifugal force observed in operation and in combination with the bottom surface of these recesses, a vibratory damping friction. Due to the possibility of providing large-dimension friction surfaces, the contact pressures are advantageously reduced, and the wear of the pieces slows down. Nonetheless, bearing points could be provided on these friction surfaces, for example three bearing points to have an isostatic system available. In such a case, the recesses are judiciously positioned to locate the bearing points in the desired arrangement.

In addition, the path reconstituting member may also have a simple design making it easy to manufacture, for example by forming a plate, such as a machined and/or deformed and/or cut plate.

The recesses in the heel portions make it possible, for their part, not only to reduce thickness of these heel portions, but also to impart better aerodynamic performance to the reconstituted path, by housing/embedding all or part of the thickness of the reconstituting member in these two recesses.

By duplicating the principle of the invention on several assemblies of two adjacent vanes of the impeller, or even on the entire vaned impeller, the adjacent path reconstituting members provide satisfactory aerodynamic continuity of the path. Advantageously, this generates less disturbances than with the prior solutions consisting in assembling friction elements to the interface between the heels, at their circumferential faces which cooperate two by two. In addition, axial and radial sealing is thereby advantageously improved.

Furthermore, the inventive general concept that emerges from the two formulations of the invention, respectively via claims 1 and 6, also relies on structuring the heel portions in the circumferential direction to cooperate and retain the member for reconstituting the path, forming a dynamic friction damper. This structuring is carried out in the first case by removing material with the presence of the circumferential notches, while in the second case, structuring is carried out by adding material with the radial retention tabs.

This structuring of the heel portions in the circumferential direction, specific to the present invention, allows the retention means of the reconstituting member to extend in length along this same circumferential direction, and not in the axial direction. Since the space available in the circumferential direction proves to be greater than that in the axial direction of the vanes, implantation of the radial retention means is thereby facilitated, and their performance improved.

Finally, this same inventive concept of circumferentially structuring the heel portions makes it possible to overcome the design restriction encountered in some solutions of prior art, imposing a damper radial support that necessarily extends radially between two heel portions facing each other.

The invention preferably provides at least any one of the following optional characteristics, taken alone or in combination.

Preferably, in order to have increased aerodynamic performance at the gas circulation path, the radially inner surface of the reconstituting member, and the radially inner surface of the first and second heel portions accommodating this reconstituting member, are flush. The preferential characteristics recited below apply to the first definition of the invention, by claim 1.

Preferably, each pair of attachment notches cooperates with a radial retention element belonging to said radial retention means, the radial retention element being a tab or a rail, and, in the case of the tab, the latter preferably has a circumferential length greater than or equal to the cumulative circumferential length of the two notches of the pair of attachment notches concerned. Furthermore, the circumferential length of the tab may be greater than or equal to that of the plate.

Preferably, the plate of the reconstituting member is equipped with a single radial retention element, for example axially centered on this plate, or the plate of the reconstituting member is equipped with several radial retention elements axially spaced apart from each other, for example two radial retention elements respectively arranged at the two axially opposite ends of the plate and radially outwardly arranged as a protrusion from the same.

Preferably, the heel of each of the first and second adjacent vanes comprises two sealing members radially outwardly protruding from the base and they are axially spaced apart from each other, and there is provided, within each of the first and second heel portions:
an attachment notch axially arranged between the two sealing members; or
two attachment notches axially arranged on either side of the assembly formed by the two sealing members; or
an attachment notch axially arranged between the two sealing members and an attachment notch axially offset from the assembly formed by the two sealing members.

These embodiments are combinable and others are possible, such as for example providing two attachment notches axially arranged between the two sealing members.

Regardless of the preferred embodiment contemplated, the heel of each of the two adjacent vanes forms, in both orientations of the axial direction of the impeller, upstream and downstream spoilers.

Preferably, a path reconstituting member is arranged between each assembly of two adjacent vanes of the impeller, implying that these members are circumferentially separated from each other by the blade tips.

Preferably, the vanes are made of a ceramic matrix composite material, even if other materials may be contemplated, without departing from the scope of the invention. The path reconstituting member may also be made of a ceramic matrix composite material. It could also be made of metal material.

Preferably, it is a fixed or movable vaned impeller, of a compressor or turbine, and preferably a low-pressure turbine impeller.

Finally, another object of the invention is an aircraft turbomachine, such as a twin-spool turbofan, comprising at least one such vaned impeller.

Other advantages and characteristics of the invention will appear in the non-limiting detailed description below.

### BRIEF DESCRIPTION OF THE DRAWINGS

This description will be made with regard to the appended drawings, wherein:

FIG. 1 shows a schematic longitudinal cross-section view of an aircraft turbomachine according to the invention;

FIG. 2 represents a more detailed perspective view of a vaned impeller of a low-pressure turbine of the turbomachine shown in the previous figure, the vaned impeller having the form of a first preferred embodiment of the invention;

FIG. 3 represents a partial and enlarged perspective view of a part of the vaned impeller shown in the previous figure, viewed radially from inside;

FIG. 4 represents a view similar to the previous one, with the path reconstituting member having been removed for the sake of clarity;

FIG. 5 represents a perspective view of one of the two vanes shown in FIGS. 3 and 4;

FIG. 6 represents a perspective view of the other of the two vanes shown in FIGS. 3 and 4;

FIG. 7 is a perspective view of the path reconstituting member shown in FIG. 3;

FIG. 8 represents a perspective view similar to that of FIG. 3, viewed radially from outside;

FIG. 9 represents a partial and enlarged perspective view of a part of the vaned impeller according to a second preferred embodiment of the invention, viewed radially from inside;

FIG. 10 represents a view similar to the previous one, with the path reconstituting member having been removed for the sake of clarity;

FIG. 11 represents a perspective view of one of the two vanes shown in FIGS. 9 and 10;

FIG. 12 represents a perspective view of the other of the two vanes shown in FIGS. 9 and 10;

FIG. 13 is a perspective view of the path reconstituting member shown in FIG. 9;

FIG. 14 represents a perspective view similar to that of FIG. 9, at another viewing angle;

FIG. 15 represents a view similar to that of FIG. 13, with the path reconstituting member being in the form of an alternative;

FIG. 16 represents a view similar to that of FIG. 13, with the path reconstituting member being in the form of another alternative;

FIG. 17 is a perspective view similar to that of FIG. 14, integrating the path reconstituting member shown in FIG. 16;

FIG. 18 represents a partial and enlarged perspective view of a part of the vaned impeller according to a third preferred embodiment of the invention, viewed radially from inside;

FIG. 19 represents a view similar to the previous one, with the path reconstituting member having been removed for the sake of clarity;

FIG. 20 is a perspective view of the path reconstituting member shown in FIG. 18;

FIG. 21 represents a perspective view similar to that of FIG. 18, at another viewing angle;

FIG. 22 represents a cross-section view of a part of the vaned impeller according to a fourth preferred embodiment of the invention, this cross-section being taken along line XXII-XXII of FIG. 25;

FIG. 23 represents a view similar to the previous one, with the path reconstituting member having been removed for the sake of clarity;

FIG. 24 is a perspective view of the path reconstituting member shown in FIG. 22;

FIG. 25 represents a part of the impeller according to the fourth preferred embodiment, viewed radially from inside; and

FIG. 26 represents a view similar to that of FIG. 22, with the path reconstituting member being itself in the form of an alternative.

### DETAILED DISCLOSURE OF PREFERRED EMBODIMENTS

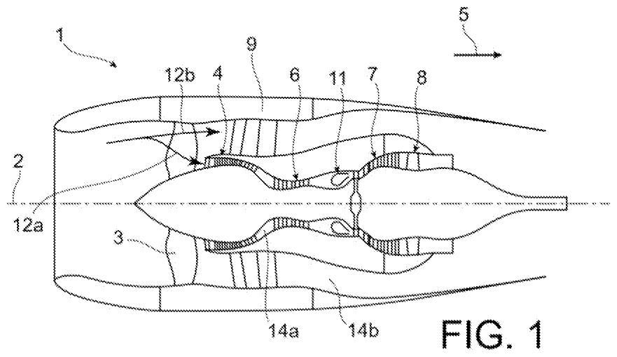

Referring firstly to FIG. 1, an aircraft turbomachine 1 is represented, according to a preferred embodiment of the invention. This is a twin-spool turbofan. Nevertheless, it could be a turbomachine of another type, for example a turboprop engine, without departing from the scope of the invention.

The turbomachine 1 has a longitudinal central axis 2 around which its various components extend. It comprises, from upstream to downstream along a main direction 5 of flow of gases through this turbomachine, a fan 3, a low-pressure compressor 4, a high-pressure compressor 6, a combustion chamber 11, a high-pressure turbine 7 and a low-pressure turbine 8. The fan 3 may be directly driven by a low-pressure body comprising the compressor 4 and the turbine 8, or may be indirectly driven by a reduction gear (not represented).

Conventionally, after passing through the fan 3, air divides into a central primary flux 12a and a secondary flux 12b that surrounds the primary flux. The primary flux 12a flows into a main gas circulation path 14a passing through the compressors 4, 6, the combustion chamber 11 and the turbines 7, 8. The secondary flux 12b in turn flows in a secondary flux path 14b radially outwardly delimited by a motor casing, surrounded by a nacelle 9.

Each turbine 7, 8 and each compressor 4, 6 conventionally comprises and as known to those skilled in the art, alternating movable vaned impellers and fixed vaned impellers, centered on the axis 2. The invention lies in the design of these vaned impellers, and more particularly in the dynamic damping principle that is embedded therein.

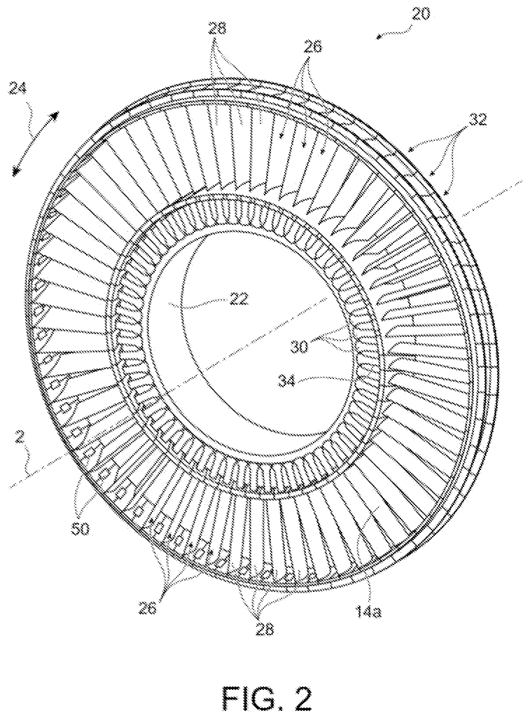

FIG. 2 shows a movable vaned impeller 20 according to a first preferred embodiment of the invention, this impeller being preferably intended to form a part of the low-pressure turbine 8. Nevertheless, the invention may apply to the high-pressure turbine 7, or even to one of the two compressors 4, 6. Moreover, it may be a fixed vaned impeller, without departing from the scope of the invention.

The vaned impeller 20 comprises a disk 22, centered on the axis 2 and to which a plurality of distinct vanes 26 forming an annular row of vanes are radially outwardly mounted. Each vane 26 comprises a blade 28 forming the aerodynamic part of the vane, as well as a root 30 and a heel 32. In a known manner, the root 30 is formed by a part with a greater thickness, for example with a bulb-shaped section, which is engaged in a corresponding housing 34 arranged at the periphery of the disk 22.

Radially outwardly opposite the root 30, the blade 28 of the vane carries the heel 32, the latter being therefore integral with the blade tip, and preferably made of a single piece with the other parts thereof.

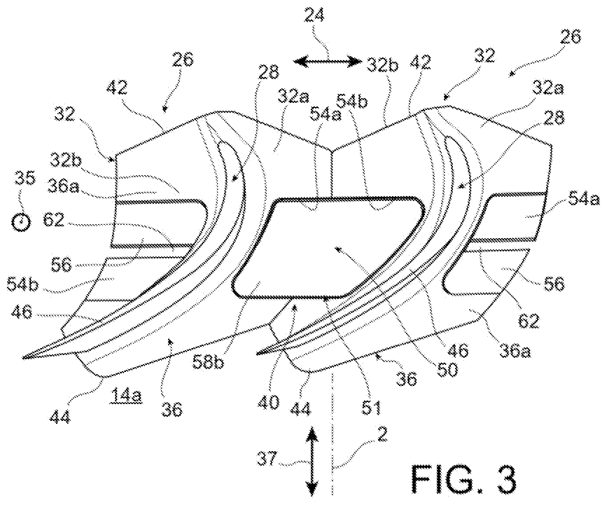

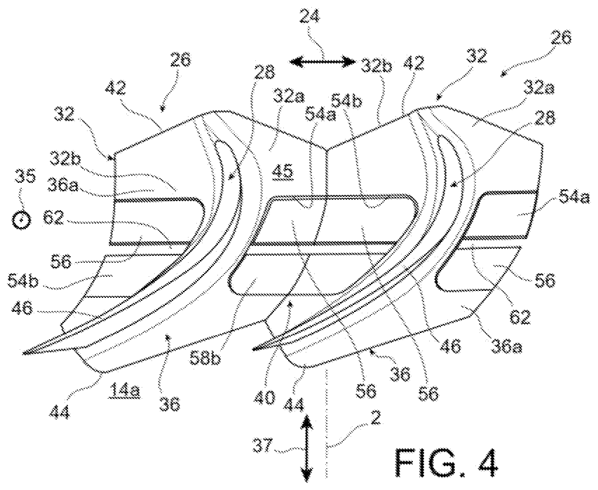

FIGS. 3 and 4 show more detailed views of a plurality of adjacent vanes 26 of the impeller 20, here two vanes 26 that succeed each other adjacently along the circumferential direction 24. It is noted that all the vanes of the impeller 20 preferably have an identical or similar design. In these figures, the left vane 26 is referred to as the first vane, while the right vane 26 is referred to as the second vane.

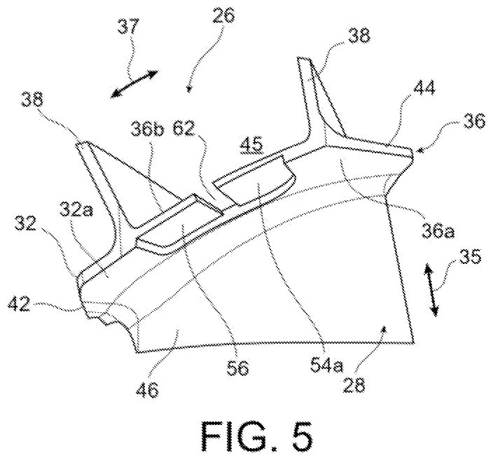

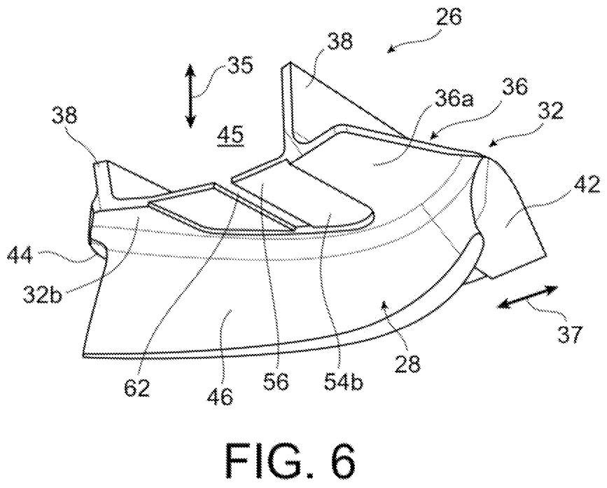

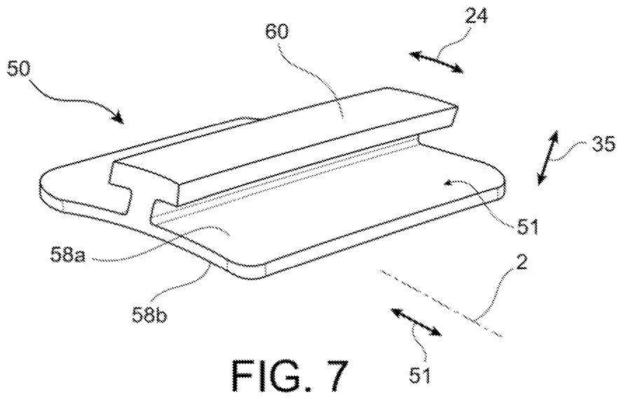

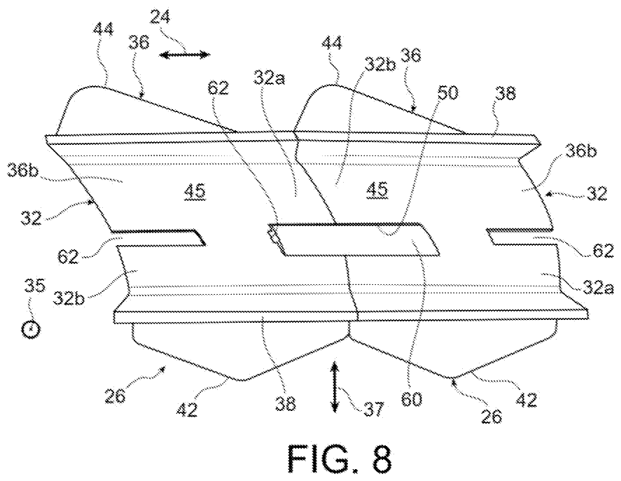

With reference jointly to FIGS. 3 to 8 concerning the first preferred embodiment of the invention, the heel 32 of one of the vanes 26, integral with the tip 46 of the blade 28 of this same vane, will first be described.

The heel 32 comprises a base 36, as well as one or more sealing members 38 extending radially outwardly from this base. Here, it is two sealing members 38 that radially outwardly protrude from the base 36, and are axially spaced apart from each other. The members 38 take the form of wipers extending outwardly in a radial direction 35 of the vane along which the root 30 and the heel 32 are spaced apart from each other, and they also extend circumferentially over the entire circumferential length of the heel 36.

In the description, the terms inner/outer and internal/external, associated with the radial direction 35, are defined with respect to each vane in its environment, and therefore with respect to the root of the vane which radially forms the innermost part of this vane.

With regard to the aforementioned wipers 38, a slight axial inclination thereof is possible, such as an upstream inclination, without departing from the scope of the invention. Nevertheless, they are preferably oriented along the circumferential direction 24. The wipers 38 have a distal end radially facing an internal surface of a turbine casing (not represented). They are used to control sealing with this turbine casing, in the operating configuration of the turbojet (turbofan). Indeed, these wipers 38 are intended to come as close as possible to the surface of the casing in order to provide a sealing function with respect to the primary flux 12a, which passes through the rotating movable bladed impeller 20.

The two wipers 38 as well as the base 36 together form an U-shaped structure delimiting a cavity 45 radially outwardly opened, and usually referred to as “bathtub”. The base 36 of the heel extends, in the axial direction 37 parallel to the axis 2, beyond the two wipers 38 in both orientations. In other words, it axially extends beyond the two wipers 38 on either side of the base of the heel 32, so as to form an upstream spoiler 42 and a downstream spoiler 44 respectively. Consequently, these two spoilers and the central part of the base of the heel together form a platform radially outwardly delimiting the primary path.

To enhance mechanical strength of the heel 32, one or more ribs (not represented) can connect the two wipers 38, by being arranged on the radially outer surface 36b of the base of the heel.

Unlike embodiments of prior art, the blade heels 32 do not delimit the entire main path 14a, the latter being also delimited by path reconstituting members 50 specific to the present invention, distinct from the heels 32 and arranged between the adjacent vanes 26 which hold these same members 50 in place.

In order to be able to cooperate with two path reconstituting members 50 on either side of the blade, each heel 32 extends circumferentially on either side of the blade tip 46 forming respectively a first heel portion 32a, as well as a second heel portion 32b. In the figures, the first heel portion 32a corresponds to that on the right, i.e. on the upper surface side of the blade, while the second heel portion 32b corresponds to that on the left, i.e. on the lower surface side of the blade. At the base 36, each of the first and second heel portions 32a, 32b has a radially inner surface 36a partly radially outwardly delimiting the path 14a.

Between each assembly of two adjacent vanes 26 of the impeller, namely two directly consecutive vanes along the circumferential direction 24, there is provided this path reconstituting member 50, forming a plate 51, for example a cut and/or deformed and/or machined plate, or even a molded plate. Other manufacturing methods remain possible, without departing from the scope of the invention. The reconstituting member 50 is preferably made of a metallic material or preferably of CMC material, while the aforementioned vanes 26 are also preferably made of CMC material.

The plate 51, which corresponds to the main part of the path reconstituting member 50, at least partly extends over the thickness of the first heel portion 32a of the first vane 26, and of the second heel portion 32b of the directly consecutive second vane.

For this purpose, the reconstituting member 50 has a part arranged in a first recess 54a provided on the radially inner surface 36a of the first heel portion 32a of the first vane, and another circumferentially adjacent part, which is for its part arranged in a second recess 54b provided on the radially inner surface 36a of the second heel portion 32b of the second vane. The first and second recesses 54a, 54b are in the form of indentations over the thickness of the base 36 of the heel, with a non-closed indentation contour. Indeed, the two adjacent recesses 54a, 54b circumferentially open toward each other, and they therefore also radially inwardly open to accommodate the reconstituting member 50, preferably filling the entirety of these recesses.

Opposite to their ends which face each other in the circumferential direction 24, each recess 54a, 54b has a circumferential end which is preferably close to the blade tip of its vane. In the axial direction 37, each recess 54a, 54b preferably extends over the thickness of the base 36 at the space defined between the two wipers 38, with its two axial ends even more preferably moving closer to, radially in line with, these wipers, respectively.

Each recess 54a, 54b has a radially inner bottom surface 56, for cooperating by friction with a radially outer friction surface 58a of the reconstituting member 50, a radially inner surface 58b of which partly radially outwardly delimits the path 14a.

For achieving better aerodynamic performance on the primary flux passing through the path 14a, it is preferably envisaged that the radially inner surface 58b of the reconstituting member 50, and the radially inner surface 36a of the first and second heel portions 32a, 32b accommodating this member, are flush. In other words, the member 50 fills the entirety of the two recesses 54a, 54b by preferably preserving very small assembly clearances, and above all, the member 50 does not extend outside these recesses in the radial direction 35.

When all the path reconstituting members 50 are mounted within the impeller 20, they are spaced apart from each other along the circumferential direction 24 by the blade tips 46. Thus, together, they form a partial ring of reconstituting the main path 14a, centered on the axis 2, circumferentially interrupted by these blade tips 46, and partly internally delimiting this same path 14a having a satisfactory aerodynamic continuity. By being at the junction between two adjacent vanes, the members 50 also participate in limiting radial gas leaks.

The members 50 thus retain a simple shape to manufacture, while fulfilling several functions such as that of reconstituting the main path, or that of sealing the path along the radial direction 35.

Another feature of the invention lies in taking advantage of the dissociation of the pieces described above, to form a dynamic damping device 40. Indeed, the cooperation of the friction surfaces 58a, 56 makes it possible, in the event of vibratory excitation, to form a dynamic damping device 40 of the vanes.

More specifically, each reconstitution member 50 is therefore the seat of a dynamic damping device 40, with its surface 58a which cooperates by friction on the one hand with the recess bottom surface 56 of the first heel portion 32a of the first vane, and on the other hand with the recess bottom surface 56 of the second heel portion 32b of the second vane. Thus, each reconstitution member 50 is associated with the two vanes 26 which are arranged on either side thereof, to form together with them a dynamic damping device 40, and to ensure that it is held in position.

Indeed, in this first preferred embodiment, the path reconstituting member 50 is equipped with the means for radially retaining the plate in the first and second recesses 54a, 54b. Here, it is a rail-shaped radial retention element 60 that circumferentially extends along the entire length of the plate 51, radially outwardly protruding from the outer friction surface 58a of this same plate.

The radial retention rail 60, for example of T-shaped cross-section, cooperates with two attachment notches 62 respectively made in the first heel portion 32a of the first vane, and in the second heel portion 32b of the second vane. Each attachment notch 62 herein circumferentially extends by radially passing through its associated heel portion 32a, 32b. Furthermore, it circumferentially opens toward the other of the two notches 62, in order to form a pair of attachment notches 62 circumferentially aligned, and substantially in continuity with each other.

The base of the T-rail 60 thus passes through the pair of notches 62 with a small clearance, while the head of the T cooperates with the radially outer surface 36b of the heel to ensure radial retention of the reconstituting member 50. In the event of radial clearance in this mounting, it is completed in operation due to the centrifugal effect to which the member 50 is subjected, allowing it to cooperate by friction with the two radially inner bottom surfaces 56 of the recesses 54a, 54b.

In this first preferred embodiment, the axial retention element 60 comprising the axial retention means is unique, for example axially centered on the plate 51.

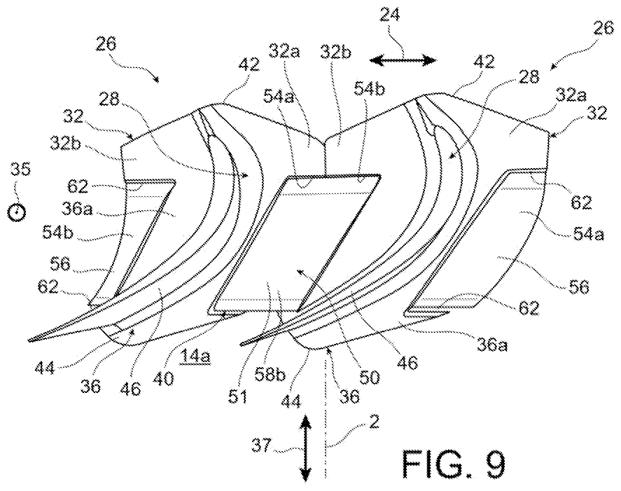

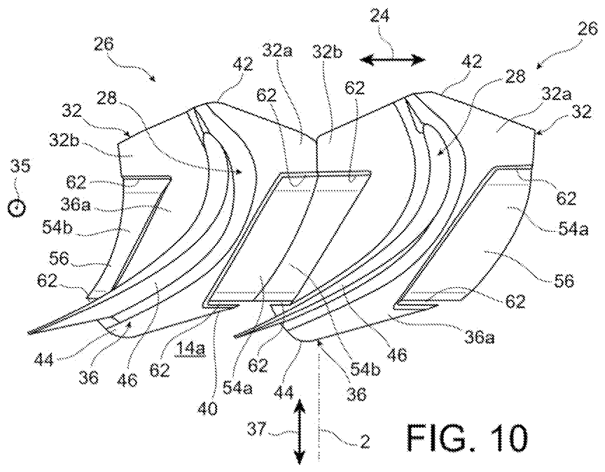

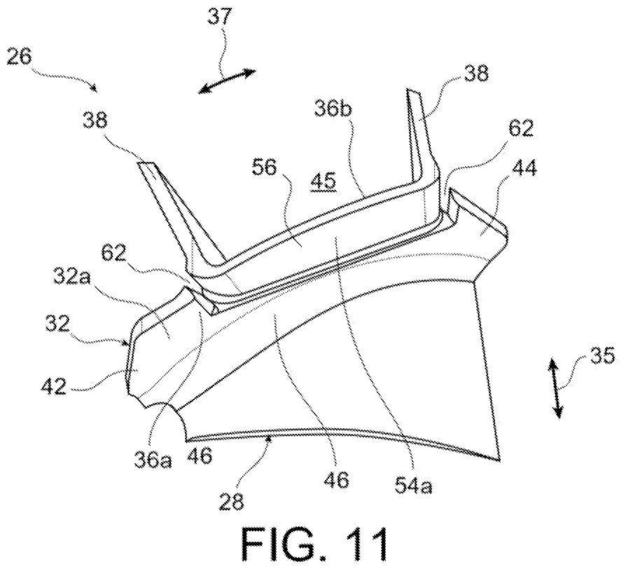

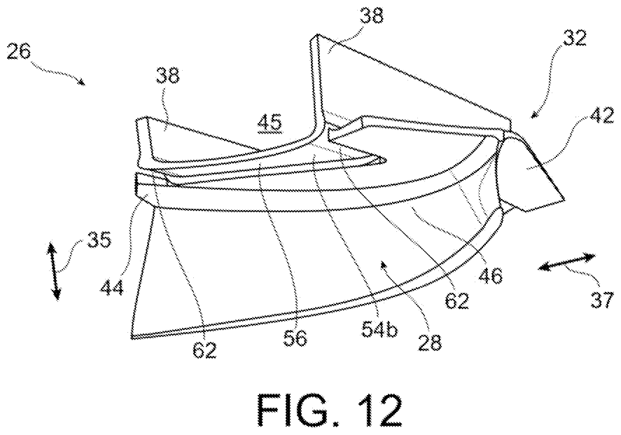

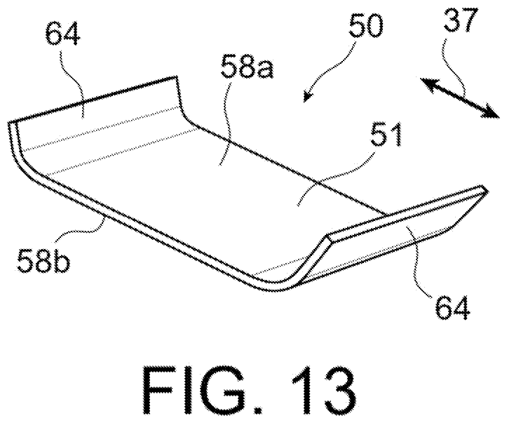

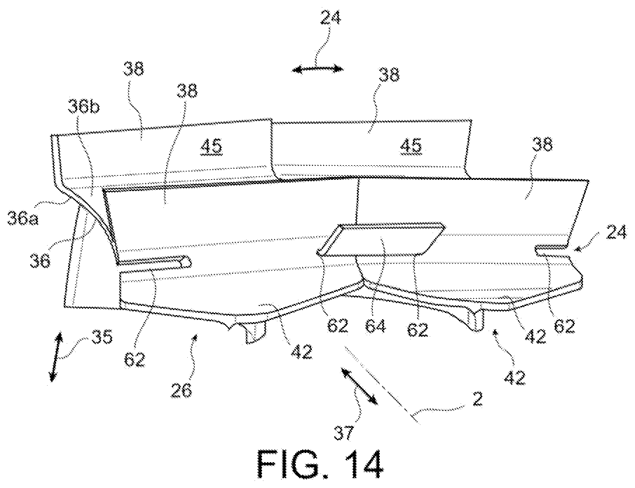

According to a second preferred embodiment represented in FIGS. 9 to 14, two radial retention elements 64 are provided, respectively arranged at the two opposite axial ends of the plate 51, and radially outwardly arranged as a protrusion from the same. These two elements each take the form of a tab 64. Here, the circumferential length of each tab 64 is equal to or substantially equal to that of the plate 51, and to that of the cumulative circumferential length of the two notches 62 of the pair of notches through which the tab concerned radially passes.

Two pairs of attachment notches 62 are therefore provided herein to cooperate respectively with the two tabs 64, located at the two axial ends of the plate 51. The two notches 62 on the first heel portion 32a of the first vane are axially arranged on either side of the assembly formed by the two sealing members 38, preferably leading to the heel at the foot of these members 38, externally to the aforementioned assembly. The same applies to the two notches 62 provided on the second heel portion 32b of the second vane. The inclination of the tabs 64 relative to the radial direction 35 allows the member 50 to be radially retained in its two dedicated recesses 54a, 54b. Indeed, the tabs 64 cooperate with the radial surface 36b of the heel located opposite the upstream 42 and downstream 44 spoilers.

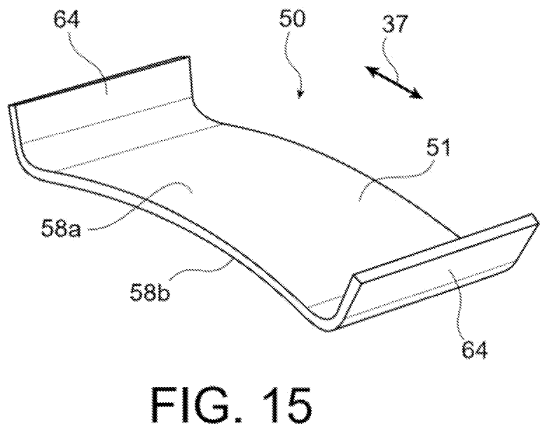

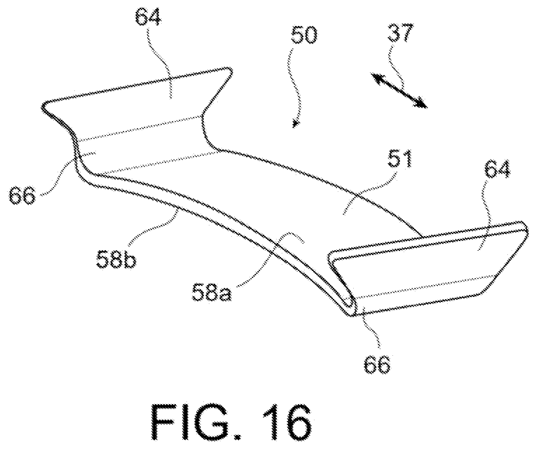

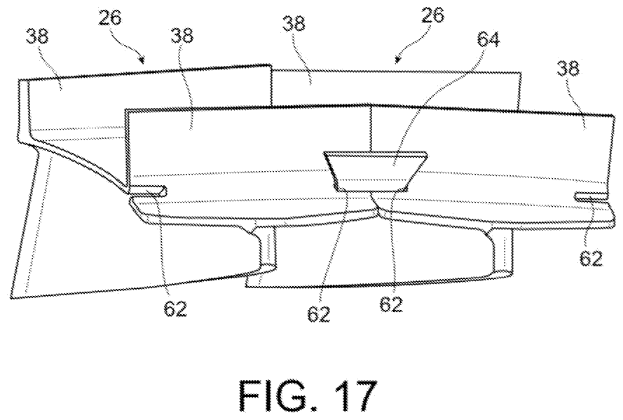

FIG. 15 represents an alternative for making the reconstituting member 50, in which the plate 51 is not planar, but it has a curvature in the axial direction 37. FIGS. 16 and 17 represent another alternative, in which the two tabs 64 are no longer of an overall rectangular shape. They have a trapezoidal shape radially outwardly flaring, from the junction 66 with the plate 51, which junction corresponds to the part radially passing through the pair of notches 62, and having a circumferential length equal to or substantially equal to the cumulative circumferential length of the two notches 62 of the pair through which it passes.

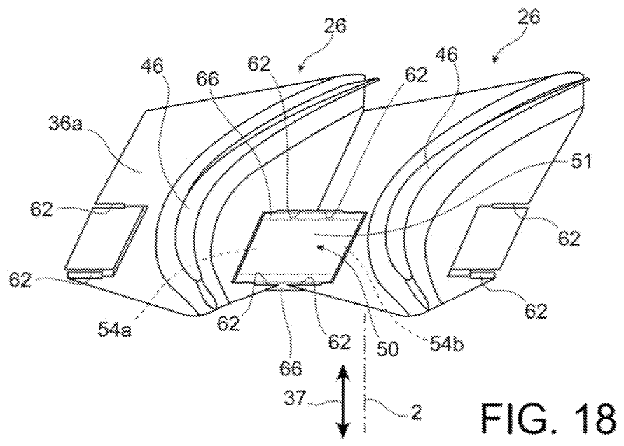

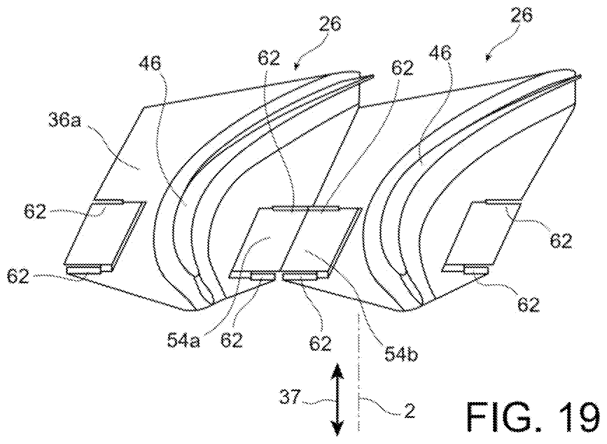

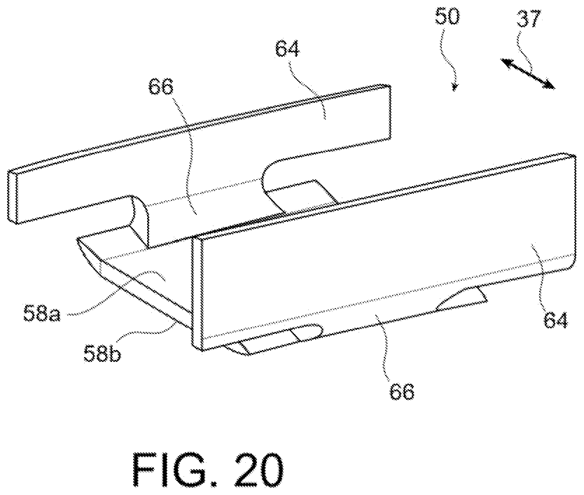

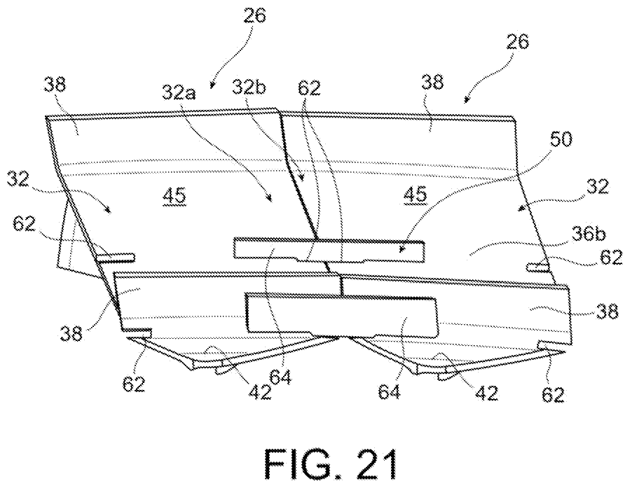

FIGS. 18 to 21 show a third preferred embodiment of the invention, wherein the reconstituting member 50 has two tabs 64 with junctions 66 of circumferential length shorter than that of the tab body, of general rectangular shape. This makes it possible to provide notches 62 with a shorter circumferential length.

Moreover, in this third embodiment, if one of the two attachment tabs 64 cooperates with a pair of attachment notches 62 axially offset from the assemblies formed by the sealing members 38, for example by leading to the foot of two of these members 38 arranged in circumferential continuity with each other, the other tab 64 in turn cooperates with a pair of notches 62 axially arranged between the sealing members 38, for example axially centered on the first and second heel portions 32a, 32b.

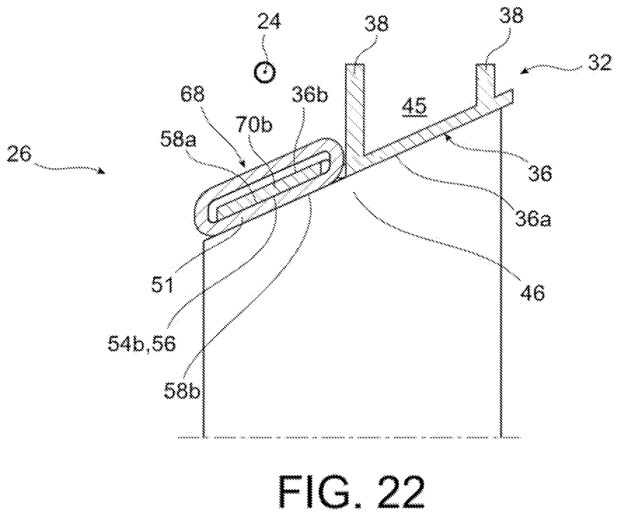

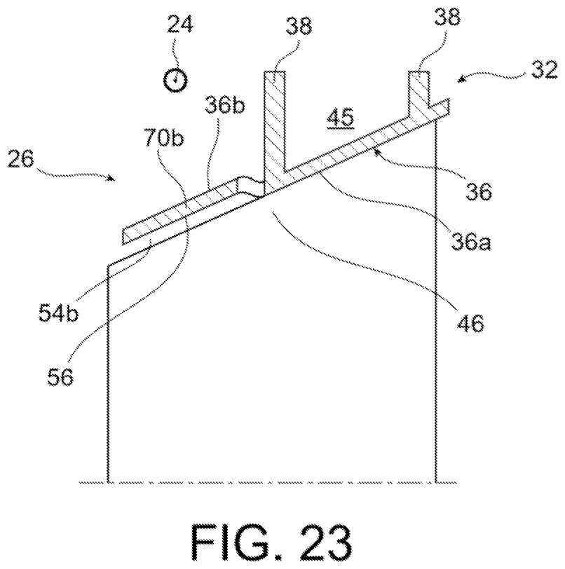

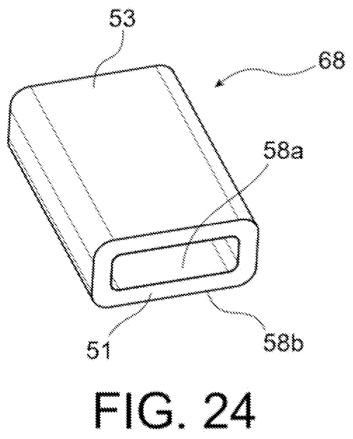

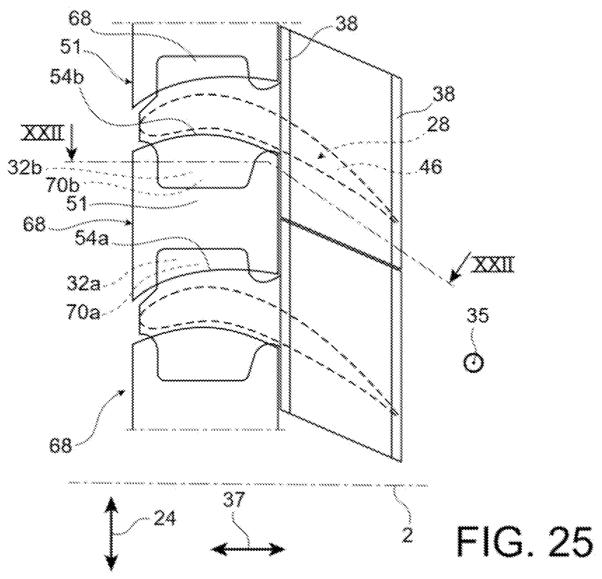

With reference now to FIGS. 22 to 25, a fourth preferred embodiment of the invention is represented, contrasting with the previous embodiments essentially in that the plate 51 of the reconstituting member 50 corresponds to a part of a flattened tube 68.

In this fourth embodiment, the first heel portion 32a of the first vane comprises a first radial retention tab 70a circumferentially extending toward the second vane, and similarly, the second heel portion 32b of the second vane comprises a second radial retention tab 70b circumferentially extending toward the first tab 70a. These tabs 70a, 70b have a reduced radial thickness, and they define the two recesses 54a, 54b on the radially inner surface 36a of the heel 36. Moreover, these tabs are axially offset from the leading edge side of the vanes, and each initiated in proximity to the blade tip 46, to then extend as a protrusion in the circumferential direction 24.

The plate 51 of the reconstituting member 50 therefore corresponds to a radially inner part of a flattened tube 68. Here also, the radially outer surface 58a of the plate 51 cooperates by friction with the bottom surfaces 56 of the recesses 54a, 54b, these surfaces 56 corresponding to the radially inner surfaces of the radial retention tabs 70a, 70b.

The other part of the flattened tube 68, namely the radially outer part also in the form of a plate 53 with curved edges for the junction with the plate 51, constitutes the means for radially retaining this plate 51 by radially outwardly covering the first and second tabs 70a, 70b. Indeed, at its two opposite circumferential ends, the flattened tube 68 is penetrated by the first and second tabs 70a, 70b, which allows not only to form the friction damping device between the surfaces 56, 58a, but also to retain the plate 51 in all directions 24, 35, 37. The two ends of the flattened tube 68 thus form hollow radial retention means, respectively penetrated by the first and second radial retention tabs 70a, 70b.

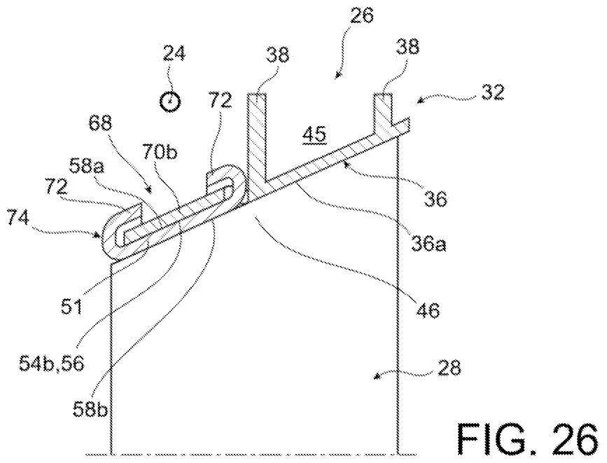

According to an alternative, the flattened tube 68 can be split along the circumferential direction 24. According to yet another alternative shown in FIG. 26, the flattened tube is replaced with a radially outwardly opening C-shaped cross-section structure 74. The reconstituting member 50 then integrates hooks 72 at the opposite axial edges of the plate 51, to form the means for radially retaining this plate by cooperating with the axial edges of the tabs 70a, 70b, which penetrate the hooks.

Of course, various modifications may be made by a person skilled in the art to the invention just described, only by way of non-limiting examples and within the scope of the appended claims. In particular, the technical characteristics of the different preferred embodiments and alternatives thereof are interchangeable and/or cumulative.

What is claimed is:

1. A vaned impeller for aircraft turbomachine, the impeller comprising several vanes succeeding each other along a circumferential direction of the impeller so as to form an annular row of vanes, each of the vanes comprising a blade as well as a heel integral with the blade tip and radially outwardly arranged as a protrusion from the same, the heel comprising a base as well as at least one sealing member radially outwardly protruding from the base, the heel circumferentially extending on either side of the blade tip respectively into a first heel portion, and a second heel portion, each of the first and second heel portions having a radially inner surface partially delimiting a gas circulation path,
wherein between adjacent first vane and second vane of the impeller, the latter also comprises a member for reconstituting the gas circulation path, the reconstituting member being arranged in a first recess provided on the radially inner surface of the first heel portion of the first vane, and in a second recess provided on the radially inner surface of the second heel portion of the second vane, the first and second recesses circumferentially opening toward each other, and each having a radially inner bottom surface for cooperating by friction with a radially outer friction surface of the reconstituting member, a radially inner surface of which partially delimits the path
in that the path reconstituting member forms a plate,
and in that the path reconstituting member comprises means for radially retaining the plate in the first and second recesses, the radial retention means cooperating with attachment notches made in the first heel portion of the first vane and in the second heel portion of the second vane, each attachment notch circumferentially extending and passing through its associated heel portion by circumferentially opening toward another attachment notch, in order to form one or more pairs of attachment notches circumferentially aligned two by two.

2. The vaned impeller according to claim 1, wherein the radially inner surface of the reconstituting member, and the radially inner surface of the first and second heel portions accommodating this reconstituting member, are flush.

3. The vaned impeller according to claim 1, wherein each pair of attachment notches cooperates with a radial retention element belonging to said radial retention means, the radial retention element being a tab or a rail and, in the case of the tab, the latter preferably has a circumferential length greater than or equal to the cumulative circumferential length of the two attachment notches of the pair of attachment notches concerned.

4. The vaned impeller according to claim 3, wherein the plate of the reconstituting member is equipped with a single radial retention element, for example axially centered on this plate, or in that the plate of the reconstituting member is equipped with several radial retention elements axially spaced apart from each other, for example two radial retention elements respectively arranged at the two axially opposite ends of the plate and radially outwardly arranged as a protrusion from the same.

5. The vaned impeller according to claim 1, wherein the heel of each of the first and second adjacent vanes comprises two sealing members radially outwardly protruding from the base and are axially spaced apart from each other, and in that there is provided, within each of the first and second heel portions:
an attachment notch axially arranged between the two sealing members; or
two attachment notches axially arranged on either side of the assembly formed by the two sealing members; or
an attachment notch axially arranged between the two sealing members and an attachment notch axially offset from the assembly formed by the two sealing members.

6. A vaned impeller for aircraft turbomachine, the impeller comprising several vanes succeeding each other along a circumferential direction of the impeller so as to form an annular row of vanes, each of the vanes comprising a blade as well as a heel integral with the blade tip and radially outwardly arranged as a protrusion from the same, the heel comprising a base as well as at least one sealing member radially outwardly protruding from the base the heel circumferentially extending on either side of the blade tip respectively into a first heel portion, and a second heel portion, each of the first and second heel portions having a radially inner surface partially delimiting a gas circulation path,
wherein between adjacent first vane and second vane of the impeller, the latter also comprises a member for reconstituting the gas circulation path, the reconstituting member being arranged in a first recess provided on the radially inner surface of the first heel portion of the first vane, and in a second recess provided on the radially inner surface of the second heel portion of the second vane, the first and second recesses circumferentially opening toward each other, and each having a radially inner bottom surface for cooperating by friction with a radially outer friction surface of the reconstituting member, a radially inner surface of which partially delimits the path
in that the path reconstituting member forms a plate,
and in that the first heel portion of the first vane comprises a first radial retention tab circumferentially extending toward the second vane, the second heel portion of the second vane comprising a second radial retention tab circumferentially extending toward the first radial retention tab, and in that the path reconstitution member comprises, at its two opposing circumferential ends, hollow radial retention means respectively penetrated by the first and second radial retention tabs, and,
preferably, the path reconstituting member integrating hooks at the opposite axial edges of the plate to form said radial retention means, or the plate corresponds to a part of a flattened tube, another part of which forms said radial retention means by radially outwardly covering the first and second radial retention tabs.

7. The vaned impeller according to claim 6, wherein the radially inner surface of the reconstituting member, and the radially inner surface of the first and second heel portions accommodating this reconstituting member, are flush.

8. The vaned impeller according to claim 1, wherein the vanes and/or the reconstituting members are made of a ceramic matrix composite material.

9. An aircraft turbomachine comprising at least one vaned impeller according to claim 1.
